(19) United States
(12) Patent Application Publication
(10) Pub. No.: US 2020/0262442 A1
(43) Pub. Date: Aug. 20, 2020

(54) STATE DETERMINATION DEVICE

(71) Applicant: DENSO CORPORATION, Kariya-city, Aichi-pref. (JP)

(72) Inventors: Takahiro NAITO, Kariya-city (JP); Noriko KATO, Kariya-city (JP); Katsuyoshi NISHII, Kariya-city (JP)

(21) Appl. No.: 16/063,721

(22) PCT Filed: Sep. 26, 2016
(86) PCT No.: PCT/JP2016/078144

§ 371 Date: Jun. 19, 2018

(30) Foreign Application Priority Data
Dec. 24, 2015 (JP) 2015-251642

(51) Int. Cl. B60W 40/09; G08B 21/06; G08G 1/16

(52) U.S. Cl. CPC B60W 40/09; G08G 1/16; G08B 21/06

(57) ABSTRACT

A state determination device for a driver state of a movable body includes: a behavior acquisition section for behavior information of the movable body; a check section that sets a threshold region where the behavior information relating to a careless driving of the movable body is distributed, the threshold region having two or more stages of a determination region, and checks current behavior information with a set stage of the determination region; a determination section that determines a careless driving when the current behavior information is included in the set stage; a time acquisition section that acquires an elapsed time from a driving start of the movable body; and a change section that changes the set stage to another stage having a higher possibility of determination of the careless driving when a careless time is equal to or less than a predefined threshold.

### CROSS REFERENCE TO RELATED APPLICATION

This application is based on Japanese Patent Application No. 2015-251642 filed on Dec. 24, 2015, the disclosure of which is incorporated herein by reference.

### TECHNICAL FIELD

The present disclosure relates to a state determination device that determines the state of a driver who drives a movable body.

### BACKGROUND ART

As described in Patent Literature 1, there is known a state determination device that is mounted on a vehicle and determines whether a driver is carelessly driving. In the state determination device described in Patent Literature 1, it is determined whether careless driving is being performed according to a result of a comparison between steering information which is an index relating to steering and a predefined threshold.

There are variations in the steering information due to individual differences between drivers or changes in the physical condition or the degree of fatigue even in the same driver.

However, in the technique described in Patent Literature 1, the threshold to be compared with the steering information is one fixed value. Thus, even if a driver is carelessly driving, the conventional technique may erroneously determine that the driving is not careless driving.

That is, it is required in the conventional technique to improve the accuracy of determination whether driving is careless driving.

### PRIOR ART LITERATURES

### Patent Literature

Patent Literature 1: JP-H09-123790-A

### SUMMARY OF INVENTION

It is an object of the present disclosure to provide to provide a state determination device that improves the accuracy of determination whether driving is careless driving.

According to a first aspect of the present disclosure, a state determination device that determines a state of a driver who drives a movable body, includes: a behavior acquisition section that acquires behavior information indicating behavior of the movable body; a check section that sets at least one threshold region where the behavior information relating to a careless driving of the movable body is distributed, the at least one threshold region having two or more stages of a determination region where the behavior information corresponding to a degree of the careless driving is distributed, and checks current behavior information acquired by the behavior acquisition section with a set stage of the determination region; a determination section that determines that the driver carelessly drives the movable body when the current behavior information is included in the set stage of the determination region according to a result checked by the check section; a time acquisition section that acquires an elapsed time from a driving start of the movable body; and a change section that changes the set stage of the determination region to another stage of the determination region having a higher possibility of determination of the careless driving when a careless time that is a period in which the determination section determines that the driver carelessly drives the movable body with respect to the elapsed time acquired by the time acquisition section is equal to or less than a predefined threshold.

Some drivers cannot stabilize the behavior of a movable body, which increases fluctuations in behavior information with the elapse of time. When an elapsed time from the start of driving of a movable body by such a driver becomes long, and the driver becomes sleepy or absent-minded, a period of careless driving occurs.

In such a condition, when the careless time is extremely short, it is considered that a determination region which is used in determination whether the driver is carelessly driving, that is, the set determination region is not adapted to the driver.

On the other hand, in the state determination device, when the careless time is extremely short, the determination region used in the determination is changed to a determination region having a higher possibility of determination of careless driving.

As a result, according to the state determination device, even if the physical condition of the driver changes due to daily changes in the physical condition or intra-day variations in the physical condition, the determination region used in the determination can be set to an optimal region which is adapted to the physical condition of the driver. Further, according to the state determination device, even if there are individual differences between drivers, the determination region used in the determination can be set to an optimal region which is adapted to each of the drivers.

Thus, according to the state determination device, it is possible to reduce erroneous determinations that careless driving is determined to be non-careless driving.

In other words, according to the state determination device, it is possible to improve the accuracy of determination whether driving is careless driving.

### BRIEF DESCRIPTION OF DRAWINGS

The above and other objects, features and advantages of the present disclosure will become more apparent from the following detailed description made with reference to the accompanying drawings. In the drawings:

FIG. 1 is a block diagram illustrating a schematic configuration of a state determination system;

FIG. 2 is a diagram illustrating an example of a determination model which is used in determination of the state of a driver;

FIG. 3 is a flowchart illustrating a procedure of a state determination process;

FIG. 4 is a flowchart illustrating a procedure of a threshold setting process;

FIG. 5A is a graph showing the relationship of speed and steering with an elapsed time;

FIG. 5B shows a result obtained by evaluating whether driving is careless driving and the driver is fatigued subjectively by the driver;

FIG. 5C shows an evaluation result by the state determination process; and

FIG. 6 is a diagram illustrating a modification of the determination model which is used in the determination of the state of a driver.

### EMBODIMENTS FOR CARRYING OUT INVENTION

Hereinbelow, an embodiment of the present disclosure will be described with reference to the drawings.

<1. State Determination System>

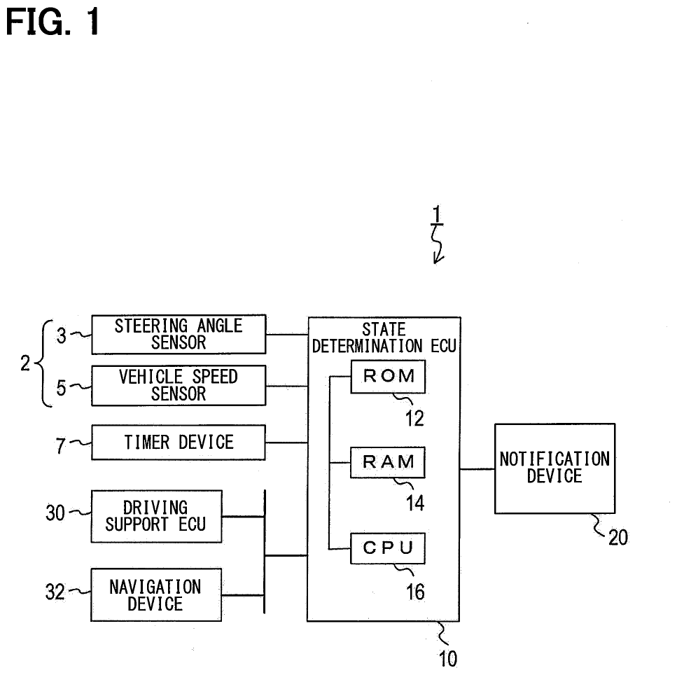

A state determination system 1 illustrated in FIG. 1 is a system that is mounted on a four-wheeled vehicle as a movable body and determines the state of a driver of the movable body. The state of the driver described herein includes whether the driver is carelessly driving. Further, the “careless driving” means driving with less concentration, for example, driving with a low awakening level, driving with a high degree of fatigue, or absent-minded driving.

The state determination system 1 includes a sensor group 2, a timer device 7, a state determination electronic control unit 10, a notification device 20, a driving support electronic control unit 30, and a navigation device 32. Hereinbelow, the state determination electronic control unit is referred to as a state determination ECU. Further, the driving support electronic control unit is referred to as a driving support ECU. ECU is an abbreviation for “electronic control unit”.

The sensor group 2 includes a plurality of sensors that detect the behavior of an own vehicle. The sensor group 2 includes a steering angle sensor 3 and a vehicle speed sensor 5.

The steering angle sensor 3 is a known sensor that measures the angle of a steering of the own vehicle. The vehicle speed sensor 5 is a known sensor that measures a rotation speed of each wheel of the own vehicle. In the present embodiment, an average value in the rotation speed of the wheel measured in the vehicle speed sensor 5 may be measured as a moving speed (that is, the vehicle speed) of the own vehicle.

The timer device 7 is a known device that measures the current time.

The notification device 20 is a known device that notifies information according to a control signal from the state determination ECU 10. The notification device 20 includes, for example, at least either a display device which displays information or a voice output device which outputs information using a voice. The display device in the present embodiment includes, for example, a display and a warning light.

The driving support ECU 30 is an electronic control unit that implements a driving support function for supporting the driver so as to improve the safety in traveling of a vehicle. The driving support function described herein is a function that controls the behavior of the movable body so as to support driving of the own vehicle by the driver. The driving support function includes a longitudinal direction control function and a lateral direction control function.

The longitudinal direction control function is a function that controls the behavior of the movable body so as to support an action of the movable body in the length direction of the movable body. Concrete examples of control that implements the longitudinal direction control function include cruise control and adaptive cruise control. The cruise control is known control that maintains the vehicle speed of the own vehicle at a predefined target speed. The adaptive cruise control is a known control that maintains the distance between a preceding vehicle and the own vehicle at an appropriate distance.

The lateral direction control function is a function that controls the behavior of the movable body so as to support an action of the movable body in the width direction of the movable body. Concrete examples of control that implements the lateral direction control function include lane keeping assist. The lane keeping assist is known control that recognizes a lane shape of a traveling road on which the own vehicle is traveling and controls the steering so that the own vehicle does not depart from the lane of the traveling road.

The driving support ECU 30 is mainly composed of a known microcomputer that includes at least a ROM, a RAM, and a CPU. An onboard control device, an onboard device, and a periphery monitoring device (all of which are not illustrated) are connected to the driving support ECU 30. The onboard control device described herein includes at least a brake control device, an engine control device, and a steering mechanism. The onboard device described herein includes a warning buzzer, a monitor, a cruise control switch, and a target following distance setting switch.

That is, the driving support ECU 30 implements the driving support function by controlling the onboard control device and the onboard device on the basis of target information from the periphery monitoring device and the lane shape.

Further, the driving support ECU 30 of the present embodiment outputs an active signal to the state determination ECU 10. When the driving support function is active, the active signal indicates that the driving support function is active and indicates details of the active driving support function.

The navigation device 32 is a known device that guides a route to a set destination. The navigation device 32 includes a position detector, an input device, a storage device, and a navigation ECU.

The position detector detects information required for detection of the current position and the bearing of a traveling direction of the own vehicle. The input device receives input of information.

The storage device is a rewritable and nonvolatile storage device. Map data which indicates the structure of a road is stored in the storage device. The map data includes various data such as node data, link data, cost data, topographic data, mark data, intersection data, road type data, and facilities data. The road type data indicates the type of a road.

The type of a road described herein is an index that indicates a relative degree of possibility of careless driving on the road. For example, a road having a high relative degree of possibility of careless driving includes an expressway. The expressway described herein is an automobile road on which automobiles travel at high speed.

On the other hand, a road having a low relative degree of possibility of careless driving includes an ordinary road. The ordinary road described herein is a road used for transportation of light vehicles and pedestrians in addition to automobiles through which all objects pass.

The navigation ECU is a known electronic control unit that includes a ROM, a RAM, and a CPU. The navigation ECU identifies the current position (e.g., the latitude, the longitude, and the altitude) of the own vehicle according to information detected by the position detector. The navigation ECU guides a route to a set destination according to the identified current position of the own vehicle. Further, the navigation ECU outputs the type of a road corresponding to the current position of the own vehicle to the state determination ECU 10.

Hereinbelow, a road corresponding to the current position of the own vehicle, that is, a road on which the own vehicle is currently present is referred to as a traveling road.

<2. State Determination ECU>

The state determination ECU 10 is mainly composed of a known microcomputer that includes at least a ROM 12, a RAM 14, and a CPU 16. The ROM 12 stores processing programs and data whose storage contents are required to be held even when power is turned off. The RAM 14 temporarily stores processing programs and data. The CPU 16 executes various processes in accordance with the processing programs stored in the ROM 12 and the RAM 14.

The ROM 12 of the state determination ECU 10 stores a processing program for the state determination ECU 10 to execute a state determination process. The state determination process is a process of determining the state of the driver of the own vehicle, that is, whether the driver is carelessly driving according to a result of check of behavior information based on a sensing result in the sensor group 2 with a determination region of a threshold region.

Further, the ROM 12 of the state determination ECU 10 stores a processing program for the state determination ECU 10 to execute a threshold setting process. The threshold setting process is a process of setting a determination region (hereinbelow, referred to as a set determination region) of a threshold region with which behavior information is checked in the state determination process.

Further, the ROM 12 of the state determination ECU 10 stores a determination model which is used in the state determination process.

<3. Determination Model>

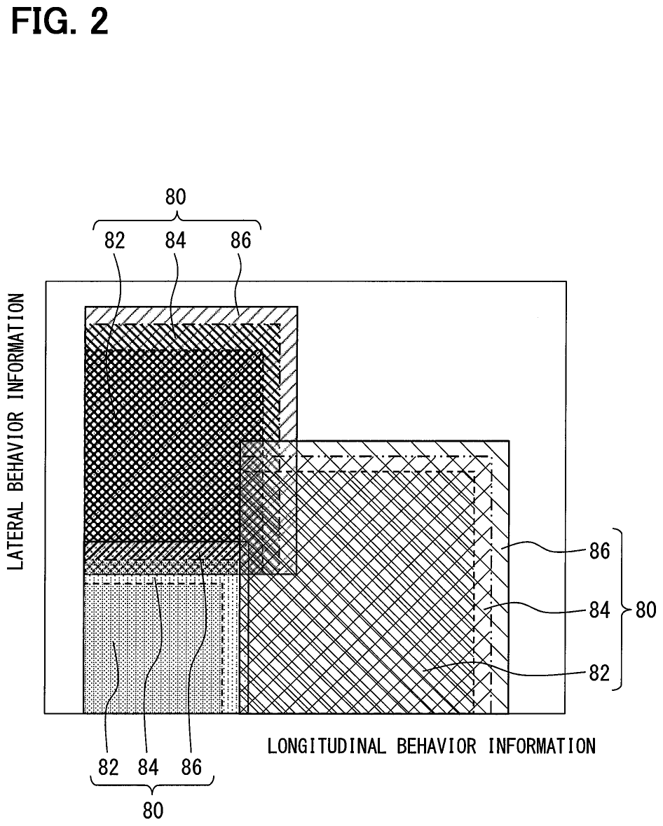

As illustrated in FIG. 2, the determination model includes at least one threshold region 80.

The threshold region 80 is a range of the distribution of behavior information in a state in which the driver is carelessly driving and previously defined on the basis of, for example, a result of an experiment. The threshold region 80 in the present embodiment indicates a range of the distribution of a correlation between lateral behavior information and longitudinal behavior information.

The threshold region 80 is defined in such a manner that threshold regions of respective classes representing the type of characteristics common in drivers at least partially have no overlap with each other.

In the present embodiment, the number of classes is three, that is, the determination model includes three threshold regions.

Further, each of the threshold regions 80 includes at least two stages of determination regions.

Each of the determination regions is a region where behavior information is distributed according to the degree of careless driving. Each of the determination regions in the present embodiment indicates a range of the distribution of the correlation between lateral behavior information and longitudinal behavior information.

The lateral behavior information described herein is information that indicates the behavior of the vehicle in the width direction of the vehicle. Examples of the lateral behavior information include a steering angle itself, an angular velocity of the steering angle, an angular acceleration of the steering angle, and a jerk of the steering angle.

The longitudinal behavior information described herein is information that indicates the behavior of the vehicle in the length direction of the vehicle. Examples of the longitudinal behavior information include a vehicle speed of the own vehicle, an acceleration of the own vehicle, and a jerk of the own vehicle.

The stages of the determination regions are prepared from a first level region 82 to an N-th level region 86. Note that “N” described herein is an integer of two or more, and three in the present embodiment.

The first level region 82 is a region where the possibility of determination that the driver is carelessly driving during a period of steady traveling of the own vehicle is lowest. A region where behavior information is distributed in the first level region 82 is the narrowest region among the determination regions included in the same threshold region 80.

The second level region 84 is a region where the possibility of determination that the driver is carelessly driving during a period of steady traveling of the own vehicle is higher than that in the first level region 82. A region where behavior information is distributed in the second level region 84 includes the region of the distribution in the first level region 82 and is wider than the region of the distribution in the first level region 82.

The N-th level region 86 is a region where the possibility of determination that the driver is carelessly driving during a period of steady traveling of the own vehicle is highest. A region where behavior information is distributed in the N-th level region 86 includes the region of the distribution in the second level region 84 and is the widest region among the determination regions included in the same threshold region 80.

<4. State Determination Process>

Next, a state determination process executed by the state determination ECU 10 will be described.

The state determination process is started by an input of a predetermined startup command. The input of the startup command may be turning-on of an ignition switch.

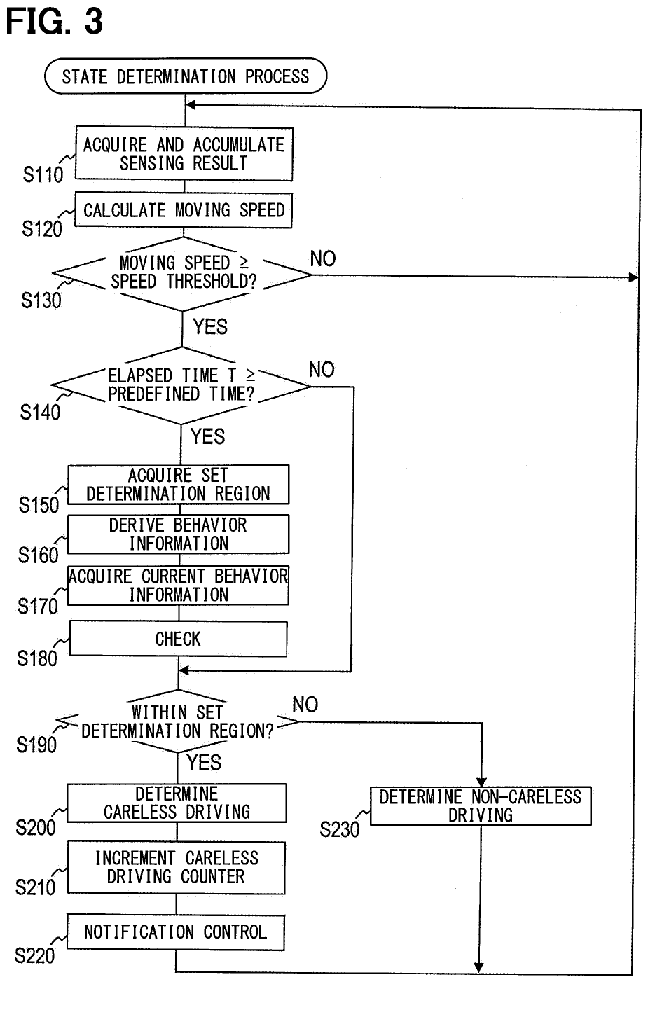

When the state determination process is started, as illustrated in FIG. 3, the state determination ECU 10 first acquires a sensing result in the sensor group 2 and stores the sensing result in association with the current time (S110). Then, the state determination ECU 10 calculates a moving speed (that is, the vehicle speed) which is a speed by which the own vehicle is moving on the basis of a rotation speed of the wheel acquired from the vehicle speed sensor 5 in S110 (S120).

In the state determination process, the state determination ECU 10 determines whether the moving speed calculated in S120 is equal to or more than a predefined speed threshold (S130). When a result of the determination in S130 shows that the moving speed is less than the speed threshold (S130: NO), the state determination ECU 10 returns the state determination process to S110. On the other hand, when a result of the determination in S130 shows that the moving speed is equal to or more than the speed threshold (S130: YES), the state determination ECU 10 shifts the state determination process to S140.

In S140, the state determination ECU 10 determines whether an elapsed time T which is an elapsed time from the input of the startup command, that is, the length of time elapsed from the start of driving of the own vehicle is equal to or more than a predefined time which is a previously defined time length. The state determination ECU 10 may obtain a time length from the time when the startup command is input to the current time as the elapsed time T.

When a result of the determination in S140 shows that the elapsed time T is less than the predefined time (S140: NO), the state determination ECU 10 shifts the state determination process to S190 (described in detail below).

On the other hand, when a result of the determination in S140 shows that the elapsed time T is equal to or more than the predefined threshold (S140: YES), the state determination ECU 10 acquires a set determination region set by a threshold setting process (described in detail below) (S150).

Then, the state determination ECU 10 derives behavior information on the basis of a sensing result acquired and stored in S110 (S160). In S160, the state determination ECU 10 derives lateral behavior information and longitudinal behavior information on the basis of a sensing result stored during a period up to a point in time which is a predetermined time before the present point in time. Examples of the lateral behavior information derived in S160 include a representative value of the steering angle, a representative value of the angular velocity of the steering angle, a representative value of the angular acceleration of the steering angle, and a representative value of the jerk of the steering angle. Further, examples of the longitudinal behavior information derived in S160 include a representative value of the vehicle speed of the own vehicle, a representative value of the acceleration of the own vehicle, and a representative value of the jerk of the own vehicle. The representative value may be an average value, a median value, or a mode.

Further, the state determination ECU 10 acquires the behavior information (hereinbelow, the current behavior information) derived in S160 (S170). Then, the state determination ECU 10 checks the current behavior information acquired in S170 with the set determination region acquired in S150 (S180).

In S180, when the driving support function is active, the state determination ECU 10 determines that one of lateral behavior information and longitudinal behavior information that corresponds to the direction of the movable body in which the behavior is controlled by the driving support function is included in the set determination region. Then, the state determination ECU 10 checks the other one of the lateral behavior information and the longitudinal behavior information that has not been determined whether being included in the set determination region with the set determination region. Specifically, when the longitudinal direction control function is active, the state determination ECU 10 determines that the longitudinal behavior information is included in the set determination region. Then, it is determined whether the driver is carelessly driving on the basis of a result of check of the lateral behavior information with the set determination region.

On the other hand, when the lateral direction control function is active, the state determination ECU 10 determines that the lateral behavior information is included in the set determination region. Then, the state determination ECU 10 determines whether the driver is carelessly driving on the basis of a result of check of the longitudinal behavior information with the set determination region.

Further, in the state determination process, the state determination ECU 10 determines whether the current behavior information is within the set determination region from the result of the check in S180 (S190). When a result of the determination in S190 shows that the current behavior information is outside the set determination region (S190: NO), the state determination ECU 10 shifts the state determination process to S230 (described in detail below).

On the other hand, when a result of the determination in S190 shows that the current behavior information is within the set determination region (S190: YES), the state determination ECU 10 shifts the state determination process to S200.

In S200, the state determination ECU 10 determines that driving is careless driving and sets a careless driving flag. The careless driving is a driving state in which the driver is carelessly driving the own vehicle.

Then, the state determination ECU 10 increments a careless driving counter (S210). The careless driving counter described herein is a counter that counts the number of times that driving is determined to be careless driving. The careless driving counter is initialized at the time of starting the state determination process.

Further, in the state determination process, the state determination ECU 10 outputs a control signal to the notification device 20 so as to notify the careless driving (S220). The notification device 20 to which the control signal has been input outputs a warning of the careless driving. Details notified by the notification device 20 may be a proposal that urges the driver to take a rest or may be a combination of a warning and a proposal.

Then, the state determination ECU 10 returns the state determination process to S110.

On the other hand, in S230 to which the process shifts when the current behavior information is outside the set determination region according to the result of the determination in S190, the state determination ECU 10 determines that driving is non-careless driving and clears the careless flag. The non-careless driving is a driving state in which the driver is not carelessly driving the own vehicle.

Then, the state determination ECU 10 returns the state determination process to S110.

<5. Threshold Setting Process>

Next, a threshold setting process executed by the state determination ECU 10 will be described.

The threshold setting process is started by an input of a startup command.

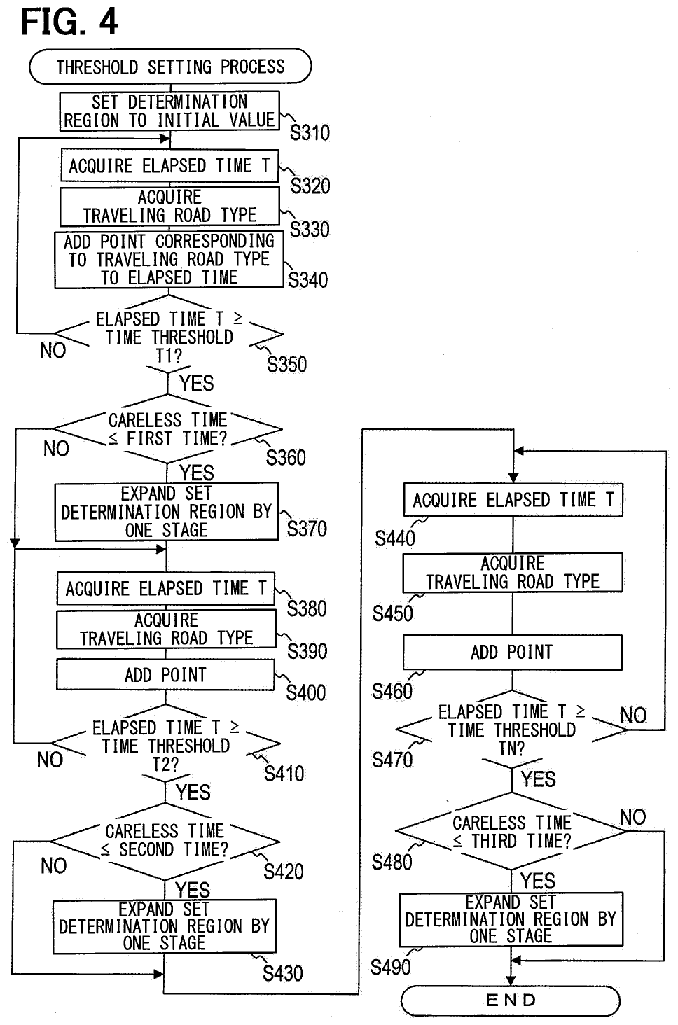

When the threshold setting process is started, as illustrated in FIG. 4, the state determination ECU 10 first sets a first level region as a set determination region (S310). Then, the state determination ECU 10 calculates an elapsed time T on the basis of time measured by the timer device 7 and acquires the calculated elapsed time T (S320).

Further, in the threshold setting process, the state determination ECU 10 acquires a traveling road type from the navigation device 32 (S330). Then, when the traveling road type acquired in S330 is a road type having a high possibility of careless driving, the state determination ECU 10 changes an object so that the elapsed time T reaches a time threshold T1 early (S340). The object in the present embodiment is the elapsed time T. Specifically, in S340, as the traveling road type is a road type having a higher possibility of careless driving, the state determination ECU 10 adds a larger value point to the elapsed time T to update the elapsed time T.

Then, in the threshold setting process, the state determination ECU 10 determines whether the elapsed time T is equal to or more than the time threshold T1 (S350). When a result of the determination in S350 shows that the elapsed time T is less than the time threshold T1 (S350: NO), the state determination ECU 10 returns the threshold setting process to S320.

On the other hand, when a result of the determination in S350 shows that the elapsed time T is equal to or more than the time threshold T1 (S350: YES), the state determination ECU 10 determines whether a careless time is equal to or less than a predefined first time (S360). The careless time is a period in which driving is determined to be careless driving with respect to the elapsed time T. In S360, the state determination ECU 10 defines, as the careless time, a period in which driving is determined to be careless driving during the elapsed time T at the point when the elapsed time T reaches the time threshold T1 and determines whether the careless time is equal to or less than the first time, which is one of predefined thresholds.

Specifically, the state determination ECU 10 determines whether a count value of the careless driving counter at the point when the process shifts to S360 is equal to or less than a first threshold. The first threshold is the number of determinations corresponding to the first time. When the count value of the careless driving counter is equal to or less than the first threshold, the state determination ECU 10 determines that the careless time is equal to or less than the first threshold.

When a result of the determination in S360 shows that the careless time is more than the first time (S360: NO), the state determination ECU 10 determines that the set determination region is appropriate and shifts the threshold setting process to S380 (described in detail below). On the other hand, when a result of the determination in S360 shows that the careless time is equal to or less than the first time (S360: YES), the state determination ECU 10 determines that the set determination region is inappropriate and shifts the threshold setting process to S370.

In S370, the state determination ECU 10 changes the set determination region to a determination region having a higher possibility of determination of careless driving in the state determination process. Specifically, in S370 of the present embodiment, the state determination ECU 10 raises the set determination region from the first level region 82 to the second level region 84.

In the following S380, the state determination ECU 10 calculates the elapsed time T on the basis of time measured in the timer device 7 and acquires the calculated elapsed time T. Further, the state determination ECU 10 acquires the traveling road type from the navigation device 32 (S390).

When the traveling road type acquired in S330 is a road type having a high possibility of careless driving, the state determination ECU 10 then changes the object so that the elapsed time T reaches a time threshold T2 early (S400). Specifically, in S400, as the traveling road type is a road type having a higher possibility of careless driving, the state determination ECU 10 adds a larger value point to the elapsed time T as the object to update the elapsed time T.

Then, in the threshold setting process, the state determination ECU 10 determines whether the elapsed time T is equal to or more than the time threshold T2 (S410). The time threshold T2 is a time length longer than the time threshold T1.

When a result of the determination in S410 shows that the elapsed time T is less than the time threshold T2 (S410: NO), the state determination ECU 10 returns the threshold setting process to S380.

On the other hand, when a result of the determination in S410 shows that the elapsed time T is equal to or more than the time threshold T2 (S410: YES), the state determination ECU 10 determines whether the careless time is equal to or less than a second time (S420). In S420, the state determination ECU 10 defines, as the careless time, a period in which driving is determined to be careless driving during the elapsed time T at the point when the elapsed time T reaches the time threshold T2 and determines whether the careless time is equal to or less than the second time, which is one of predefined thresholds.

Specifically, the state determination ECU 10 determines whether a count value of the careless driving counter at the point when the process shifts to S420 is equal to or less than a second threshold. The second threshold is the number of determinations corresponding to the second time. When the count value of the careless driving counter is equal to or less than the second threshold, the state determination ECU 10 determines that the careless time is equal to or less than the second time.

When a result of the determination in S420 shows that the careless time is more than the second threshold (S420: NO), the state determination ECU 10 determines that the set determination region is appropriate and shifts the threshold setting process to S440 (described in detail below).

On the other hand, when a result of the determination in S420 shows that the careless time is equal to or less than the second threshold (S420: YES), the state determination ECU 10 determines that the set determination region is inappropriate and shifts the threshold setting process to S430.

In S430, the state determination ECU 10 changes the set determination region to a determination region having a higher possibility of determination of careless driving in the state determination process. Specifically, in S430 of the present embodiment, the state determination ECU 10 raises the set determination region by one stage so that it is more likely to be determined in the state determination process that the driver is carelessly driving.

In the threshold setting process, steps from S380 to S430 may be repeated (N·2) times. Then, the threshold setting process may be shifted to S440 after the repetition.

In S440, the state determination ECU 10 calculates the elapsed time T on the basis of time measured in the timer device 7 and acquires the calculated elapsed time T. Further, the state determination ECU 10 acquires the traveling road type from the navigation device 32 (S450).

When the traveling road type acquired in S450 is a road type having a high possibility of careless driving, the state determination ECU 10 then changes the object so that the elapsed time T reaches a time threshold T3 early (S460). Specifically, in S460, as the traveling road type is a road type having a higher possibility of careless driving, the state determination ECU 10 adds a larger value point to the elapsed time T as the object to update the elapsed time T.

Then, in the threshold setting process, the state determination ECU 10 determines whether the elapsed time T is equal to or more than a time threshold TN (S470). The time threshold TN is a time length longer than the time threshold T2.

When a result of the determination in S470 shows that the elapsed time T is less than the time threshold TN (S470: NO), the state determination ECU 10 returns the threshold setting process to S440.

On the other hand, when a result of the determination in S470 shows that the elapsed time T is equal to or more than the time threshold TN (S470: YES), the state determination ECU 10 determines whether the careless time is equal to or less than an N-th threshold (S480). In S480, the state determination ECU 10 defines, as the careless time, a period in which driving is determined to be careless driving during the elapsed time Tat the point when the elapsed time T reaches the time threshold TN and determines whether the careless time is equal to or less than an N-th time, which is one of predefined thresholds.

Specifically, the state determination ECU 10 determines whether a count value of the careless driving counter at the point when the process shifts to S420 is equal to or less than the N-th threshold. The N-th threshold is the number of determinations corresponding to the N-th time. When the count value of the careless driving counter is equal to or less than the N-th threshold, the state determination ECU 10 determines that the careless time is equal to or less than the N-th time.

When a result of the determination in S480 shows that the careless time is more than the N-th threshold (S480: NO), the state determination ECU 10 ends the threshold setting process.

On the other hand, when a result of the determination in S480 shows that the careless time is equal to or less than the N-th threshold (S480: YES), the state determination ECU 10 determines that the set determination region is inappropriate and shifts the threshold setting process to S490.

In S490, the state determination ECU 10 changes the set determination region to a determination region having a higher possibility of determination of careless driving in the state determination process. Specifically, in S490 of the present embodiment, the state determination ECU 10 raises the set determination region by one stage so that it is more likely to be determined in the state determination process that driver is carelessly driving.

Then, the state determination ECU 10 ends the threshold setting process.

As described above, in the threshold setting process, when the careless time is extremely short, it is considered that the set determination region is not adapted to the driver. Thus, in the threshold setting process, the set determination region is changed to a determination region having a higher possibility of determination of careless driving.

### 6. Effects of Embodiment

(6. 1) According to the Threshold Setting Process, Even if the Physical condition of the driver changes due to daily changes in the physical condition or intra-day variations in the physical condition, the set determination region can be set to an appropriate region which is adapted to the physical condition of the driver. Further, according to the threshold setting process, even if there are individual differences between drivers, the set determination region can be set to an optimal region which is adapted to each of the drivers.

(6. 2) Thus, it is possible to reduce erroneous determinations that careless driving is determined to be non-careless driving in the state determination process.

In other words, according to the state determination ECU 10, it is possible to improve the accuracy of determination whether driving is careless driving.

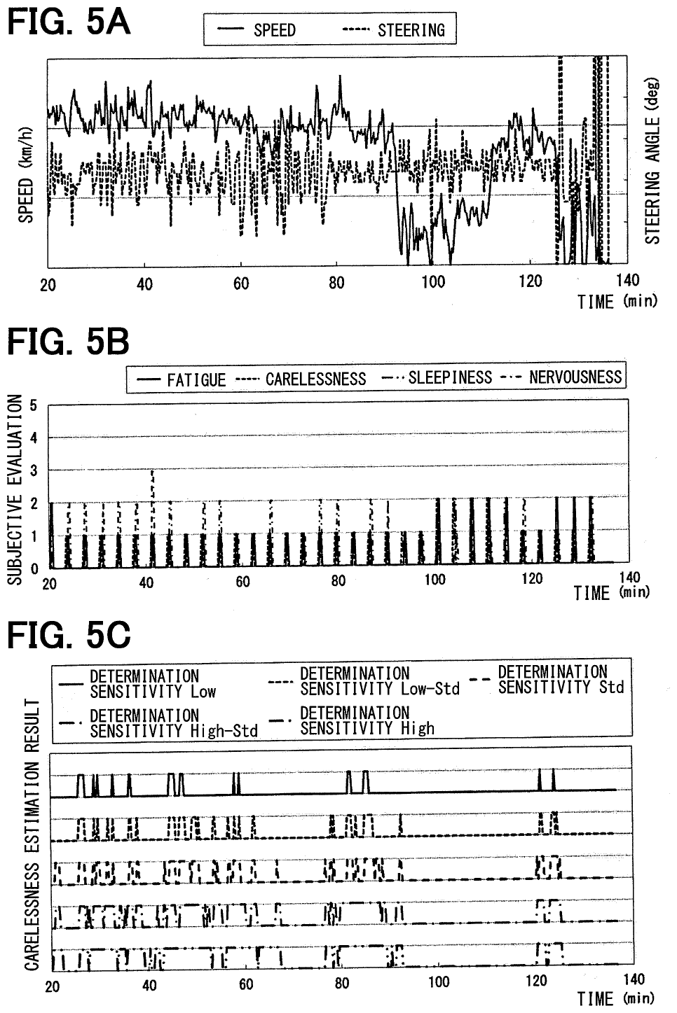

(6. 3) On the other hand, some drivers can drive a movable body with a stable behavior. When such a driver drives a movable body, as illustrated in FIG. 5A, fluctuations in the longitudinal behavior information (e.g., the vehicle speed) and the lateral behavior information (e.g., the steering angle) are small regardless of the elapsed time T.

When such a driver drives the movable body, it is possible to accurately determine whether the driver is carelessly driving from the stage in which the set determination region is set at the first level region in the threshold setting process. In this case, in the threshold setting process, the set determination region is maintained at the first level region.

According to the state determination ECU 10, even when the set determination region is maintained at the first level region, it is possible to approximate a condition of careless driving in a subjective evaluation by the driver as illustrated in FIG. 5B to an evaluation whether driving is careless driving by the state determination process as illustrated in FIG. 5C. Accordingly, the state determination ECU 10 is capable of providing an evaluation result with less sense of incongruity for the driver.

(6. 4) In the determination model in the above embodiment, the threshold regions 80 are previously defined for the respective classes that represent characteristics common in drivers in such a manner that the thresholds regions 80 at least partially have no overlap with each other.

Thus, according to the state determination ECU 10, the determination whether the driver is carelessly driving is performed on the basis of a result of check of the current behavior information with the threshold region 80 corresponding to the characteristic of the driver.

As a result, according to the state determination ECU 10, it is possible to reduce erroneous determinations caused by individual differences between drivers and further improve the accuracy of determination whether driving is careless driving.

(6. 5) When a movable body is traveling on a road having a high possibility of careless driving, it is preferred to execute the determination whether the set determination region is appropriate early in order to achieve safe operation of the movable body.

Thus, in the threshold setting process, when the traveling road type is a road type having a higher possibility of careless driving, the object is corrected so that the elapsed time T reaches the time threshold early.

Accordingly, in the threshold setting process, it is possible to execute the determination whether the set determination region is appropriate early and achieve the change of the set determination region early.

(6. 6) Further, in the four-wheeled vehicle equipped with the driving support ECU 30, when the driving support function is active, the behavior in either the width direction of the vehicle or the length direction of the vehicle is controlled by the driving support function. Thus, it is inappropriate to use information based on the behavior in the direction controlled by the driving support function as an index for determining the state of the driver.

On the other hand, in the state determination process, one of lateral behavior information and longitudinal behavior information that corresponds to the direction of the vehicle in which the behavior is controlled by the driving support function is included in the set determination region. Further, in the state determination process, it is determined whether the driver is carelessly driving on the basis of a result of check of the other one of the lateral behavior information and the longitudinal behavior information with the set determination region.

As a result, according to the state determination process, even when the driving support function is active, it is possible to determine whether the driver is carelessly driving.

### 7. Other Embodiments

The embodiment of the present disclosure has been described above. However, the present disclosure is not limited to the above embodiment and can be performed in various modes without departing from the gist of the present disclosure.

(7. 1) The object changed by the state determination ECU 10 in S340, S400, and S460 is not limited to the elapsed time T and may be the time threshold. In this case, as the traveling road type is a road type having a higher possibility of careless driving, the state determination ECU 10 may subtract a larger value point from the time threshold to update the time threshold.

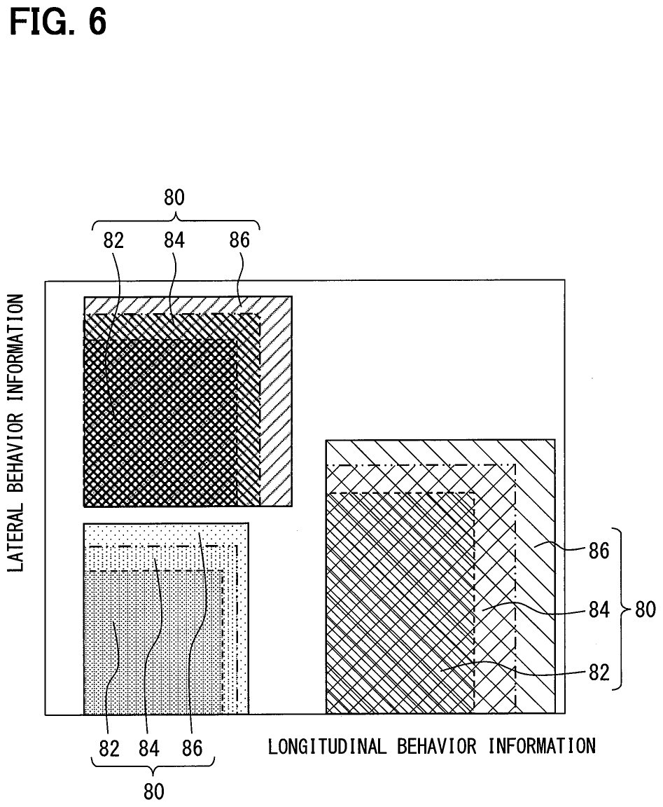

(7. 2) In the above embodiment, the determination model is defined in such a manner that the threshold regions at least partially have no overlap with each other. However, as illustrated in FIG. 6, in the determination model, ranges where behavior information is distributed in the respective threshold regions may not overlap each other.

(7. 3) In S320, S380, and S440 of the threshold setting process of the above embodiment, a starting point of the elapsed time T is the time when the startup command is input. However, the starting point of the elapsed time T is not limited thereto. For example, the starting point of the elapsed time T may be the timing when the moving speed of a movable body reaches a predefined speed threshold or more. In this case, a period in which the moving speed of the movable body is continuously equal to or more than the predefined speed threshold may be obtained and acquired as the elapsed time T.

(7. 4) In the above embodiment, a four-wheeled vehicle is assumed as the movable body. However, the movable body is not limited thereto, and may be a two-wheeled vehicle or a light vehicle.

(7. 5) Some or all of the functions executed by the state determination ECU 10 in the above embodiment may be configured as hardware by one or more ICs.

(7. 6) In the above embodiment, the programs are stored in the ROM 12. However, the storage medium that stores the programs is not limited thereto. The programs may be stored in a nontransitive and substantive storage medium such as a semiconductor memory.

(7. 7) The state determination ECU 10 may execute a program stored in a nontransitive and substantive storage medium. A method corresponding to the program is implemented by executing the program.

(7. 8) The present disclosure can be implemented in various modes such as a state determination system, a program executed by a computer for determining the state of a driver, and a method for determining the state of a driver in addition to the state control device implemented by the state determination ECU 10 described above.

(7. 9) A mode in which part of the configuration of the above embodiment is omitted is also an embodiment of the present disclosure. Further, a mode obtained by appropriately combining the above embodiment and the modifications is also an embodiment of the present disclosure. Further, all modes that are conceivable within the limit that does not depart from the nature of the disclosure specified by wording described in the claims are also embodiments of the present disclosure.

### 8. Example of Correlation

The function obtained by executing S160 to S170 of the state determination process corresponds to the behavior acquisition section. The function obtained by executing S180 corresponds to the check section. The function obtained by executing S190 and S200 of the state determination process corresponds to the determination section.

The function obtained by executing S320 to S340, S380 to S400, and S440 to S460 of the threshold setting process corresponds to the time acquisition section. The function obtained by executing S350 to S370, S410 to S430, and S470 to S490 corresponds to the change section.

The function obtained by executing S330, S390, and S450 of the threshold setting process corresponds to the type acquisition section. The function obtained by executing S340, S400, and S460 corresponds to the object change section.

It is noted that a flowchart or the processing of the flowchart in the present application includes sections (also referred to as steps), each of which is represented, for instance, as S110. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A state determination device that determines a state of a driver who drives a movable body, the state determination device comprising:
a behavior acquisition section that acquires behavior information indicating behavior of the movable body;
a check section that sets at least one threshold region where the behavior information relating to a careless driving of the movable body is distributed, the at least one threshold region having two or more stages of a determination region where the behavior information corresponding to a degree of the careless driving is distributed, and checks current behavior information acquired by the behavior acquisition section with a set stage of the determination region;
a determination section that determines that the driver carelessly drives the movable body when the current behavior information is included in the set stage of the determination region according to a result checked by the check section;
a time acquisition section that acquires an elapsed time from a driving start of the movable body; and
a change section that changes the set stage of the determination region to another stage of the determination region having a higher possibility of determination of the careless driving when a careless time that is a period in which the determination section determines that the driver carelessly drives the movable body with respect to the elapsed time acquired by the time acquisition section is equal to or less than a predefined threshold.

2. The state determination device according to claim 1, wherein:
the change section defines, as the careless time, a period in which the determination section determines that the driver carelessly drives the movable body during the elapsed time at a point when the elapsed time acquired by the time acquisition section reaches a predefined time threshold.

3. The state determination device according to claim 2, wherein:
the time acquisition section further includes:
a type acquisition section that acquires a type of a road corresponding to a current position of the movable body; and
an object change section that changes an object to reach the time threshold of the elapsed time early when the road type acquired by the type acquisition section is a road type having a higher possibility of the careless driving.

4. The state determination device according to claim 1, wherein:
the movable body has a driving support function that controls the behavior of the movable body so as to support driving of the movable body;
the behavior information includes lateral behavior information that indicates behavior in a width direction of the movable body and longitudinal behavior information that indicates behavior in a length direction of the movable body;
the determination region indicates a distribution in which the behavior information is a correlation between the lateral behavior information and the longitudinal behavior information; and
the determination section determines that one of the lateral behavior information and the longitudinal behavior information corresponding to a direction of the movable body in which the behavior is controlled by the driving support function is included in the set stage of the determination region when the driving support function is active, and determines that the driver carelessly drives the movable body, based on a check result of the other of the lateral behavior information and the longitudinal behavior information with the set stage of the determination region.

5. The state determination device according to claim 4, wherein:
the driving support function includes a longitudinal direction control function that controls the behavior of the movable body so as to support an action of the movable body in the length direction of the movable body; and
the determination section determines that the longitudinal behavior information is included in the set stage of the determination region when the longitudinal direction control function is active, and determines that the driver carelessly drives the movable body based on a check result of the lateral behavior information with the set stage of the determination region.

6. The state determination device according to claim 4, wherein:
the driving support function includes a lateral direction control function that controls the behavior of the movable body so as to support an action of the movable body in the width direction of the movable body; and
the determination section determines that the lateral behavior information is included in the set stage of the determination region when the lateral direction control function is active, and determines that the driver carelessly drives the movable body, based on a check result of the longitudinal behavior information with the set stage of the determination region.

7. The state determination device according to claim 1, wherein:
the at least one threshold region includes a plurality of threshold regions; and
each of the plurality of threshold regions has a range, where the behavior information is distributed, which is not overlapped with each other.

8. The state determination device according to claim 1, wherein:
the at least one threshold region includes a plurality of threshold regions; and
each of the plurality of threshold regions is defined by a respective characteristic of the driver.

9. The state determination device according to claim 1, wherein:
the time acquisition section acquires a period, in which a moving speed of the movable body is continuously equal to or more than a predefined speed threshold, as the elapsed time.
